(19) United States
(12) Patent Application Publication
(10) Pub. No.: US 2024/0233583 A9
(43) Pub. Date: Jul. 11, 2024

(54) RECYCLABLE GRAPHIC MEDIA

(71) Applicant: Jessup Manufacturing Company, McHenry, IL (US)

(72) Inventors: Stephen Blackowicz, Hawthorn Woods, IL (US); Ryan Duntemann, Wayne, IL (US)

(21) Appl. No.: 18/490,011

(22) Filed: Oct. 19, 2023

Related U.S. Application Data
(60) Provisional application No. 63/417,952, filed on Oct. 20, 2022.

(51) Int. Cl. G09F 7/18; C09J 7/24; C09J 7/25; C09J 7/38; C09J 7/40; G09F 19/22

(52) U.S. Cl. CPC G09F 7/18; C09J 7/243; C09J 7/255; C09J 7/385; C09J 7/401; C09J 7/405; G09F 19/228; G09F 2007/1873

(57) ABSTRACT

A recyclable graphic media includes a polymeric substrate having a first side and a second side, a release liner, and an adhesive applied to release liner. The adhesive is disposed between the release liner and the substrate. The adhesive is dissolvable from the substrate such that the substrate can be recycled. The recyclable graphic media can be a floor graphic. A release liner having a release material and an adhesive applied to the release material is also disclosed.

### CROSS-REFERENCE TO RELATED APPLICATION DATA

This application claims the benefit of and priority to Provisional U.S. Patent Application Ser. No. 63/417,952, filed Oct. 20, 2022, titled RECYCLABLE FLOOR GRAPHIC, the disclosure of which is incorporated herein in its entirety.

### BACKGROUND

This disclosure relates generally to graphic media, and more specifically, to recyclable graphic media.

Graphic media is used in so many ways. For example, floor graphics are used in commercial installations to direct floor traffic along a certain path, to indicate proper spacing between people (such as the six-foot spacing between individuals recommended during the COVID-19 pandemic), for advertising, and the like. Floor graphics can be used on streets and sidewalks, floors, and stairs. They can be used in wayfinding (and spacing), for sporting events and events, generally. Floor graphics can also be used in safety situations (e.g., to direct foot traffic, for increased grip and the like).

Graphic media can also include wall and other surface graphics. Floor graphics, wall graphics, window graphics, and other surface graphics, collectively, graphic media, can have a design, such as printing thereon for a wide variety of purposes, such as décor, promotions, wayfinding, advertising and the like.

Typical floor graphics include a high durability media substrate and an adhesive. Wall and other surface graphics can likewise include a high durability substrate and an adhesive. Most common are polyvinyl chloride (PVC) facestocks, and current adhesive technologies render these facestocks unable to be recycled. One known type of substrate is polypropylene, and more specifically, biaxially oriented polypropylene (BOPP). A wide variety of adhesives are used for such media.

While such graphic media are very well accepted in many industries and applications, they will, from time to time, require replacement, updating, etc. And in updating such graphic media, the older media are disposed of as waste, and generally not in an environmentally friendly manner. Specifically, the adhesives used to adhere the substrate to the surface to which it is secured is not recyclable and is not readily separable from the substrate. As such, the entirety of the graphic media must be disposed of as waste.

Accordingly, there is a need for recyclable graphic media. Desirably, such a graphic media is manufactured from materials all of which can be recycled, or if not all of the materials can be recycled, the minimally non-recyclable materials can be separated from the recyclable materials to eliminate or minimize materials disposed of as waste.

### SUMMARY

According to an aspect of the disclosure, a recyclable graphic media includes a polymeric substrate having a first side and a second side, and a release liner applied to the first or second side of the substrate.

The release liner can be formed from a paper or a film and a release coating material is applied to a side thereof. The release coating material can be a silicone or a silicone-based material. An adhesive is applied to the release liner on the release coating material which is then applied to the substrate. Once the release liner is applied to the substrate, the adhesive transfers to the substrate. The adhesive is removable from the substrate such that the substrate can be recycled.

The polymeric substrate can be, for example, a polyolefin, such as high density polyethylene (HDPE), oriented polypropylene (OPP), and polyethylene terephthalate (PET). The oriented polypropylene can be a biaxially oriented polypropylene (BOPP). Biaxial orientation increases the strength and clarity/transparency of the film Such a material is easy to coat, print, and laminate so that a desired appearance and properties for use (such as for use as floor graphics) are obtained. Other suitable substrate materials will be recognized by those skilled in the art.

In embodiments, the adhesive is an acrylic emulsion pressure sensitive adhesive or a form of acrylic emulsion pressure sensitive adhesive with varying performance characteristics and enhanced to improve dissolvability. The adhesive is removable from the substrate by, for example, dissolving the adhesive, preferably in water. Dissolving the adhesive does not affect recyclability of the substrate.

In embodiments, the adhesive is a first adhesive and the graphic further includes an overlay applied to the substrate and adhered to the substrate by a second layer or application of adhesive. The first and second adhesives are dissolvable from the substrate and the overlay such that the substrate and the overlay can be recycled.

The recyclable graphic media can be, for example, a floor graphic.

In another aspect, a release liner includes a paper or a film having first and second sides, and a release coating material applied to the first and seconds sides of the paper or film material. The release coating material can be silicone or a silicone-based material. The release liner can further include an adhesive applied to the release material. The release coating material on the first side of the release paper or film can be different from the release coating on the second side of the release paper or film such that when the release liner is rolled and unrolled, the adhesive remains on one side of the release paper or film. Alternatively, one or both sides of the release paper or film with the release coating material thereon can be treated or pre-treated so that one side of the release paper or film has a higher affinity for the adhesive than the other side of the release paper or film.

These and other features and advantages of the present invention will be apparent from the following detailed description, in conjunction with the appended claims.

### BRIEF DESCRIPTION OF THE DRAWINGS

FIG. 1 is a perspective exploded illustration of an embodiment of a recyclable graphic media according to the present disclosure; and

FIG. 2 is a perspective exploded illustration of another embodiment of a recyclable graphic media.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

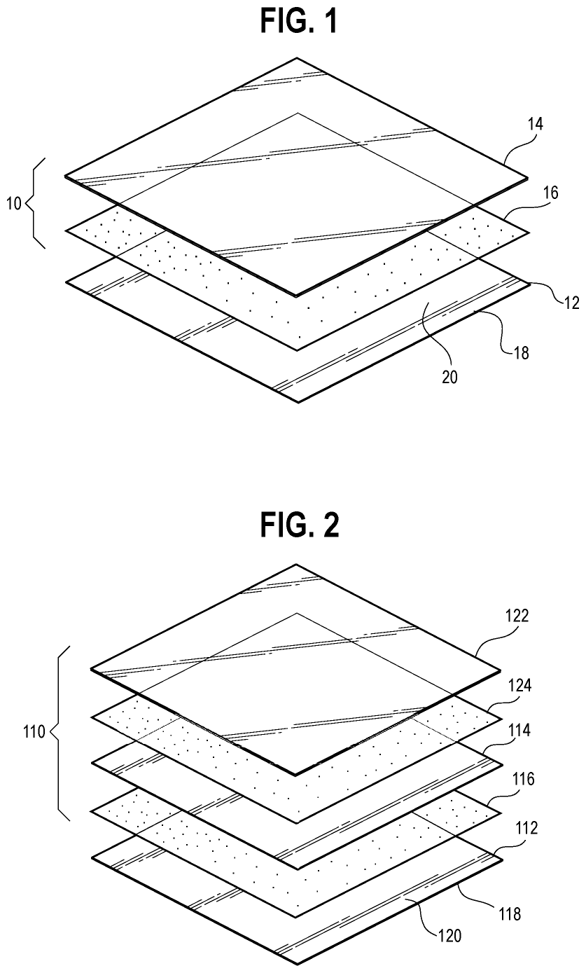

Referring now to FIG. 1, there is shown a perspective, exploded view of an embodiment of a recyclable graphic media 10 in accordance with the present disclosure, the media 10 being illustrated with a release liner 12. The media 10 itself is formed from a substrate 14 and an adhesive 16 that is applied to the substrate 14. The adhesive 16 is applied to the release liner 12 opposite the substrate 14 to allow for manufacturing, packaging, and application of the media 10. Once the substrate 14 and release liner 12 are laminated, the adhesive transfers to the substrate 14. It will be appreciated that the substrate 14 can, and typically will include a design, such as printing of a type, for example, advertising, directions instructions (wayfinding), and the like. The release liner 12 generally includes a paper, film or like material 18 having a release material 20, such as silicone, silicone-based material or like coating on a side of the paper 18 that the adhesive 16 is applied to. The release coating material 20 allows for readily removing the release liner 12 from the graphic media 10.

In an embodiment, the substrate 14 is formed from a recyclable polymer, such as polypropylene, and in embodiments, biaxially oriented polypropylene (BOPP). BOPP is polypropylene that is extruded and stretched in both the machine direction and the transverse (across the machine direction). Biaxial orientation increases the strength and clarity/transparency of the film. It is easy to coat, print, and laminate so that a desired appearance and properties for use (such as for use as floor graphics) are obtained. Such a material is also sufficiently strong and durable to function as a floor graphic and withstand substantial foot traffic. Other suitable substrate materials include high density polyethylene (HDPE), oriented polypropylene (OPP), and polyethylene terephthalate (PET), as well as other polymers, such as polyolefins.

The adhesive 16 is selected such that it provides the required durability and adhesive properties but is also separable from the substrate 14. Preferably, such an adhesive 16 can be separated from the substrate, for example by dissolving the 16 adhesive in solution that permits readily recycling the substrate 14. In embodiments, the adhesive is an acrylic emulsion pressure sensitive adhesive or a form of acrylic emulsion pressure sensitive adhesive enhanced to improve dissolvability.

Another embodiment is illustrated in FIG. 2, which is similar to the embodiment of FIG. 1 and includes media 110 formed from a substrate 114 and an adhesive 116 that is applied to the release liner 112 that is applied to the substrate 114. Once the substrate 114 and release liner 112 are laminated, the adhesive 116 transfers to the substrate 114. In this embodiment, a transparent or clear overlay 122 is applied over the substrate 114 and adhered to the substrate 114 by an adhesive 124. It is anticipated that the overlay 122 can also be formed from BOPP or a similar, highly durable, recyclable material, such as HDPE, OPP, PET, and the like. The release liner 112 generally includes a paper, film or like material 118 having a release material 120, such as silicone or like coating on a side of the paper 118 that the adhesive 116 is applied to. The release coating material 120 allows for readily removing the release liner 112 from the graphic media 110.

It is also anticipated that the overlay 122 material is adhered to the substrate 114 using an adhesive 124 similar to that used to adhere the substrate 114 to the surface to which the graphic media 110 is applied. That is, the adhesive can be an acrylic emulsion pressure sensitive adhesive or a form of acrylic emulsion pressure sensitive adhesive enhanced to improve dissolvability. In this manner, the adhesives 116, 124 can be separated from the substrate 114 and the overlay 122 and the substrate 114 and overlay 122 (as well as the release liner 112) can be recycled.

Again, it will be appreciated that the substrate 114 typically includes a design such as printing of a type, for example, advertising, directions instructions (wayfinding), and the like. When the overlay 122 is used (as in the embodiment of FIG. 2), the transparent overlay 122 can further protect the design on the substrate 114, for example, when the media is used as a floor graphic.

It is also anticipated that a release liner 12 and adhesive 16 can be formed for later lamination or application to a substrate. In such an embodiment, both sides of the release liner paper, film or like material 18 can have the release coating material 20, such as silicone applied thereto so that the release liner 12 can be rolled onto itself without the adhesive adhering to the “opposite” side of the rolled release liner 12. In such an embodiment, the release liner 12 can be later applied to a substrate, such as a recyclable substrate material. In use, as unrolled, the release liner 12 will have the adhesive 16 applied to one side and the adhesive will remain on that one side and unscathed due to rolling and unrolling the liner 12 until applied to the substrate.

In embodiments, the release coating material 20 on the first side of the release liner paper, film or like material 18 may be different from the release material 20 on the second side of the release liner paper, film or like material 18 so that the adhesive 16 has a higher affinity to one of the release coating materials 20 than the other release coating material 20 and will remain on one of the release coating materials 20 and release from the other of the release coating materials 20 when the release liner 12 is rolled and subsequently unrolled for use (e.g., application to a substrate). Alternatively, one or both sides of the release paper or film 18 with the release coating material 20 thereon can be treated or pre-treated so that one side of the release paper or film 18 with the release coating material 20 thereon (one side of the release liner 12) has a higher affinity for the adhesive 16 than the other side of the release paper or film 18 with the release coating material 20 thereon (the other side of the release liner 12).

Features from any one of the embodiments described above may be implemented in, combined, or used together with, or replace features from any of the other embodiments described above.

It is understood the various features from any of the embodiments above are usable together with the other embodiments described herein.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to directions or relative orientations, such as, but not limited to, “forward”, “rearward”, “inner”, “outer”, “upper”, “lower”, “raised”, “lowered”, “top”, “bottom”, “above”, “below”, “alongside”, “left”, and “right” are used for purposes of example and do not limit the scope of the subject matter described herein to such orientations or relative positioning.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

1. A recyclable graphic media, comprising:
a substrate having a first side and a second side;
a release liner, the release liner having a release material applied to a side thereof; and
an adhesive applied to release liner on the release material, wherein the adhesive is between the release liner and substrate,
wherein the adhesive is dissolvable from the substrate such that the substrate can be recycled.

2. The recyclable graphic media of claim 1, wherein the substrate is a polymeric material.

3. The recyclable graphic media of claim 1, wherein the polymeric material is a polyolefin.

4. The recyclable graphic media of claim 3, wherein the polyolefin is one or more of high density polyethylene (HDPE), oriented polypropylene (OPP), and polyethylene terephthalate (PET).

5. The recyclable graphic media of claim 4, wherein the oriented polypropylene is a biaxially oriented polypropylene (BOPP).

6. The recyclable graphic media of claim 1, wherein the adhesive is an acrylic emulsion pressure sensitive adhesive.

7. The recyclable graphic media of claim 6, wherein the acrylic emulsion pressure sensitive adhesive is enhanced to improve dissolvability.

8. The recyclable graphic media of claim 1, wherein the adhesive is removable from the substrate by dissolving the adhesive, and wherein dissolving the adhesive does not affect recycling the substrate.

9. The recyclable graphic media of claim 1, wherein the adhesive is a first adhesive and further including an overlay applied to the substrate and adhered to the substrate by a second adhesive, and wherein the first and second adhesives are removable from the substrate and the overlay such that the substrate and the overlay can be recycled.

10. The recyclable graphic media of claim 1, wherein the recyclable graphic media is a floor graphic.

11. The recyclable graphic media of claim 1, wherein the release liner is formed from a paper or a film and the release material is applied to a side thereof.

12. The recyclable graphic media of claim 1, wherein the release material is silicone or a silicone-based material.

13. A release liner, comprising:
a paper or a film having first and second sides; and
a release material applied to the first and seconds sides of the paper or film material.

14. The release liner of claim 13, wherein the release material is silicone or a silicone-based material.

15. The release liner of claim 13, further including an adhesive applied to the release material.

16. The release liner of claim 13, wherein the release material is a first release material and is applied to the first side of the paper or film material and wherein a second release material is applied to the second side of the paper or film material, and wherein the first release material is different from the second release material.

17. The release liner of claim 13, wherein the release material on or both of the first and second sides of the paper or film material is retreated or pre-treated to increase an affinity of the release material to the adhesive.
